(19) United States
(12) Patent Application Publication
(10) Pub. No.: US 2006/0012156 A1
(43) Pub. Date: Jan. 19, 2006

(54) Inflatable curtain with primary and secondary chambers

(75) Inventor: Kevin J. Boxey, Columbiaville, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc

(21) Appl. No.: 10/894,461

(22) Filed: Jul. 19, 2004

(51) Int. Cl. B60R 21/16

(52) U.S. Cl. 280/730.2

(57) ABSTRACT

Apparatus (10) for helping to protect an occupant of a vehicle (12) includes an inflatable curtain (14) that is inflatable away from a vehicle roof (18) of the vehicle to a position between a side structure (16) of the vehicle and a vehicle occupant. The inflatable curtain (14) includes a primary chamber (62) extending from adjacent an upper edge (70) to adjacent a lower edge (72) of the inflatable curtain. A secondary chamber (64) extends from adjacent the upper edge (70) to adjacent the lower edge (72). At least one passage (120) directs inflation fluid from the primary chamber (62) into the secondary chamber (64). The passage (120) is spaced from the upper edge (70) and the lower edge (72). The passage (120) is the only means through which to direct inflation fluid into the secondary chamber (64).

### FIELD OF THE INVENTION

The present invention relates to an inflatable apparatus for helping to protect a vehicle occupant in the event of a side impact to the vehicle and/or a vehicle rollover.

### BACKGROUND OF THE INVENTION

It is known to inflate an inflatable vehicle occupant protection device to help protect a vehicle occupant in the event of a vehicle collision. One particular type of inflatable vehicle occupant protection device is an inflatable curtain that inflates away from the roof of the vehicle downward inside the passenger compartment between a vehicle occupant and the side structure of the vehicle in the event of a side impact or rollover. A known inflatable curtain is inflated from a deflated condition by inflation fluid directed from an inflator to the inflatable curtain.

### SUMMARY OF THE INVENTION

The present invention relates to an apparatus for helping to protect an occupant of a vehicle. The apparatus includes an inflatable curtain that is inflatable away from a vehicle roof of the vehicle to a position between a side structure of the vehicle and a vehicle occupant. The inflatable curtain includes a primary chamber extending from adjacent an upper edge of the inflatable curtain to adjacent a lower edge of the inflatable curtain. A secondary chamber extends from adjacent the upper edge to adjacent the lower edge. At least one passage directs inflation fluid from the primary chamber into the secondary chamber. The passage is spaced from the upper edge and the lower edge. The passage is the only means through which to direct inflation fluid into the secondary chamber.

The present invention also relates to an apparatus for helping to protect an occupant of a vehicle that has a side structure and a roof. The apparatus includes an inflatable curtain that is inflatable away from the vehicle roof to a position between the side structure of the vehicle and a vehicle occupant. An inflator provides inflation fluid for inflating the inflatable curtain. The inflatable curtain includes a primary chamber positioned for protecting the occupant's head in a side impact, a secondary chamber, and at least one passage for directing inflation fluid from the primary chamber into the secondary chamber. The passage is sized to restrict flow into the secondary chamber so that the primary chamber is inflated to at least a predetermined pressure within a predetermined time after actuation of the inflator. The passage is also sized so that the secondary chamber is inflated to at least the predetermined pressure within a predetermined time after the primary chamber is inflated to the predetermined pressure.

The present invention further relates to an apparatus for helping to protect an occupant of a vehicle that has a side structure and a roof. The apparatus includes an inflatable curtain that is inflatable away from the vehicle roof to a position between the side structure of the vehicle and a vehicle occupant. An inflation fluid source is actuatable to provide inflation fluid for inflating the inflatable curtain. The inflatable curtain includes a primary chamber, a secondary chamber, and at least one passage for directing inflation fluid from the primary chamber into the secondary chamber. The passage is sized such that the primary chamber is inflated to at least a predetermined pressure within 25 milliseconds after actuation of the inflation fluid source. The passage is also sized such that the secondary chamber is pressurized to at least the predetermined pressure after the primary chamber is pressurized to the predetermined pressure and within 1.5 seconds after actuation of the inflation fluid source.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect a vehicle occupant illustrating the apparatus in a deflated condition in a vehicle, according to the present invention; and

FIG. 2 is a schematic view of the apparatus of FIG. 1 in an inflated condition in the vehicle.

### DESCRIPTION OF AN EMBODIMENT

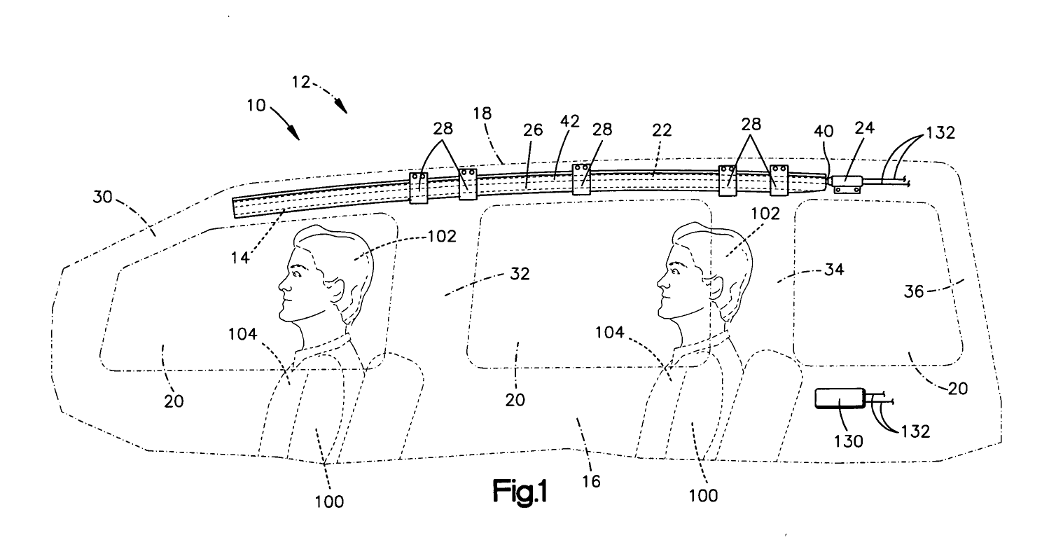

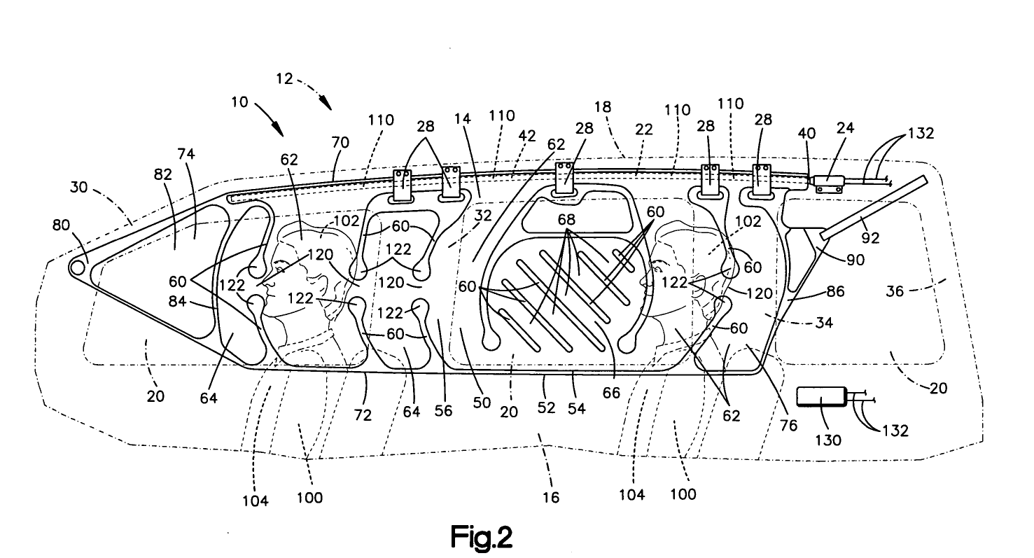

Representative of the present invention, an apparatus 10 helps to protect occupants 100 of a vehicle 12. As shown in FIGS. 1 and 2, the apparatus 10 includes an inflatable vehicle occupant protection device in the form of an inflatable curtain 14 that is mounted adjacent the side structure 16 of the vehicle 12 and the roof 18 of the vehicle. The side structure 16 of the vehicle 12 includes side windows 20, an A pillar 30, a B pillar 32, a C pillar 34, and a D pillar 36. Depending on the vehicle, both the C and D pillars could be optional. An inflator 24 is connected in fluid communication with the inflatable curtain 14 through a conduit 22, such as a fill tube. The fill tube 22 may be constructed of any suitable material, such as metal, plastic, or fabric. Also, those skilled in the art will appreciate that the fill tube 22 may be omitted, in which case the inflator 24 may be connected directly to the inflatable curtain 14.

The fill tube 22 has a first end portion 40 for receiving fluid from the inflator 24. The fill tube 22 may be connected directly to the inflator 24 or a manifold (not shown) may connect the fill tube to the inflator. The fill tube 22 has a second end portion 42 disposed in the inflatable curtain 14.

The inflator 24 contains a stored quantity of pressurized inflation fluid (not shown) in the form of a gas to inflate the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 24 could be of any suitable type or construction for supplying a medium for inflating the inflatable curtain 14.

The apparatus 10 may include a housing 26 (FIG. 1) that stores the inflatable curtain 14 in a stored and deflated condition. The fill tube 22, the deflated inflatable curtain 14, and the housing 26 have an elongated configuration and extend along the vehicle roof 18 and along the side structure 16 of the vehicle 12 above the side windows 20. The fill tube 22, inflatable curtain 14 and housing 26 are connected to the vehicle 12 by known means 28, such as brackets.

Referring to FIG. 2, the inflatable curtain 14 includes panels 50 of material that are arranged in an overlying manner. Portions of the panels 50 are secured together. For example, the panels are secured together along at least a portion of a perimeter 52 of the inflatable curtain 14 to form a perimeter connection 54 of the curtain. The perimeter connection 54 helps define an inflatable volume 56 of the inflatable curtain 14. The perimeter connection 54 may be formed in a variety of manners, such as by weaving the panels 50 as a single piece of material, stitching the panels together, or interconnecting the panels by ultrasonic welding, heat bonding, or adhesives.

The inflatable curtain 14 may also include interior connections 60 in which the overlying panels 50 are secured together within the perimeter 52 of the curtain. The interior connections 60 form non-inflatable portions of the inflatable curtain 14 within the perimeter 52 of the curtain. The interior connections 60 also help define inflatable chambers of the inflatable curtain 14. These chambers include primary chambers 62 and secondary chambers 64. The interior connections 60 also help define a central portion 66 of the inflatable curtain 14 and help define chambers 68 of the central portion 66. The configuration of the interior connections 60, and thus the chambers 62, 64, and 68, may vary depending on a variety of factors, such as the architecture of the vehicle 12, the position of the inflatable curtain 14 in the vehicle, and the desired extent or coverage of the curtain.

The panels 50 are woven from a material, such as nylon yarn, and may be coated with a gas impermeable material, such as urethane, or laminated with a gas impermeable film. The inflatable curtain 14 thus may have a substantially gas-tight construction. Those skilled in the art will appreciate that alternative materials, such as polyester yarn, and alternatives coatings, such as silicone, may also be used to construct the inflatable curtain 14.

The inflatable curtain 14 includes an upper edge 70, an opposite lower edge 72, and front and rear portions 74 and 76, respectively, that extend between the upper and lower edges. The front portion 74 includes a front edge 80 formed by the merging upper and lower edges 70 and 72. In an alternative configuration (not shown), the upper and lower edges 70 and 72 could be spaced from each other and the front edge 80 could extend between them. The front portion 74 includes a non-inflatable sail portion 82 defined by the front edge 80, the upper and lower edges 70 and 72 and a front connection 84.

The rear portion 76 includes a rear edge 86 of the inflatable curtain 14. As shown in FIG. 2, the rear portion 76 may also include a tab portion 90 for receiving a flexible elongated member 92, such as a tether, for connecting the rear portion to the vehicle 12. The perimeter 52 of the inflatable curtain 14 is defined at least partially by the upper edge 70, lower edge 72, front edge 80, and rear edge 86.

The primary chambers 62 and secondary chambers 64 extend generally vertically from adjacent the upper edge 70 to adjacent the lower edge 72 of the inflatable curtain 14. By “adjacent”, it is meant that the primary and secondary chambers 62 and 64 have upper and lower extents that terminate next to or near the upper and lower edges 70 and 72, respectively. This is meant to take into account that the perimeter connection 54 and connections 60 may help define the primary chambers 62, secondary chambers 64, or both. Thus, for example, in FIG. 2, the primary chamber 62 adjacent the front seat occupant 100 has upper and lower extents that terminate at the perimeter connection 54 next to upper and lower edges 70 and 72, respectively. The secondary chambers 64 adjacent this primary chamber 62 have lower extents that terminate at the perimeter connection 54 next to the lower edge 72 of the inflatable curtain 14, whereas their upper extents terminate at respective connections 60 near the upper edge 70.

The connections 60 defining the primary chambers 62 are configured such that respective portions 110 of the fill tube 22 are exposed to the primary chambers. This places outlet apertures (not shown) of each portion 110 of the fill tube 22 in direct fluid communication with the primary chamber 62 associated with the respective portion of the fill tube. By “direct fluid communication”, it is meant that inflation fluid from the outlet apertures (not shown) flows into the primary chamber 62 without first flowing into any other chamber.

The connections 60 defining the secondary chambers 64 are configured such that the secondary chambers are blocked from direct fluid communication with outlet apertures of the fill tube 22. This can be achieved, for example, by configuring the connections 60 to block direct fluid communication between the secondary chambers 64 and the outlet apertures of the fill tube 22, by configuring the fill tube to be free from outlet apertures in direct fluid communication with the secondary chambers, or both. In the illustrated embodiment, the connections 60 that define the secondary chambers 64 also help block direct fluid communication with the outlet apertures in the fill tube 22.

The inflatable curtain 14 includes passages 120 that provide fluid communication between the primary and secondary chambers 62 and 64. The passages 120 are defined between rounded terminal end portions 122 of certain connections 60 that help define boundaries between the primary and secondary chambers 62 and 64.

The vehicle 12 includes a sensor mechanism 130 (shown schematically in FIGS. 1 and 2) for sensing the occurrence of an event for which occupant protection is desired, such as a side impact to the vehicle 12 and/or a vehicle rollover. Upon sensing the occurrence of such an event, the sensor mechanism 130 provides an electrical signal over lead wires 132 to the inflator 24. The electrical signal causes the inflator 24 to be actuated in a known manner. The inflator 24 discharges fluid under pressure through fill tube 22, which directs the fluid into the inflatable curtain 14.

The inflatable curtain 14 inflates under the pressure of the inflation fluid from the inflator 24. The inflatable curtain 14 inflates away from the roof 18 in a downward direction as shown in the drawings and in a downward direction with respect to the direction of forward travel of the vehicle 12 into the position illustrated in FIG. 2.

The inflatable curtain 14, when inflated, extends along the side structure 16 of the vehicle 12 and is positioned between the side structure and any occupant 100 of the vehicle. The inflatable curtain 14 extends between the A pillar 30 and the C pillar 34 of the vehicle 12 and may overlie portions of the A pillar, C pillar, and B pillar 32 of the vehicle.

When the inflatable curtain 14 is in the inflated condition of FIG. 2, certain ones of the primary chambers 62 are positioned adjacent the occupants 100 of the vehicle 12 and between occupants and the vehicle side structure 16. Each of these primary chambers 62, when inflated, covers a portion of the side structure 16 adjacent its respective occupant's head 102 and a portion of its respective occupant's torso 104. The inflatable curtain 14, when inflated, thus helps to protect the vehicle occupants 100 in the event of a vehicle rollover and/or a side impact to the vehicle 12. The inflatable curtain 14, when inflated, helps to absorb the energy of impacts with the curtain and helps to distribute the impact energy over a large area of the curtain.

The primary and secondary chambers 62 and 64, when inflated, expand radially, which causes the inflatable curtain 14 to contract along its length. Since the passages 120 are positioned generally midway between the upper edge 70 and lower edge 72 of the inflatable curtain 14, the chambers 62 and 64 extend down to adjacent the lower edge of the curtain. As a result, the radial expansion of the chambers 62 and 64 causes the inflatable curtain 14 to contract lengthwise along the lower edge 72. This helps tension the inflatable curtain 14 along the lower edge 72.

The rate at which inflation fluid flows into the primary chambers can be determined through sizing the inflator 22, the fill tube 24, or the apertures (not shown) in the fill tube, or any combination of these three. The size or cross-sectional flow area of the apertures 120 can help determine the rate at which inflation fluid flows into the secondary chambers 64 from the primary chambers 62 and, thus, can help determine the time required to inflate and pressurize the secondary chambers. The apertures 120 can also help determine the time required to inflate and pressurize the primary chambers 62.

Upon actuation of the inflator 24, inflation fluid flows directly into the primary chambers 62 from the portions 110 of the fill tube 22. According to the present invention, the passages 120 are configured to help control the timing for the inflation and pressurization of both the primary chambers 62 and the secondary chambers 64. The passages 120 are sized to choke inflation fluid flow from the primary chambers 62 into the secondary chambers 64. The degree to which flow into the secondary chambers 64 is choked is determined based on the rate at which inflation fluid is directed into the primary chambers 62, as dictated by the sizing of the inflator 24, fill tube 22, and fill tube apertures (not shown). Knowing the rate at which inflation fluid enters the primary chambers 62 and the volume of the primary chambers, the passages 120 can be sized such that the primary chambers and secondary chambers 64 are inflated and pressurized within a desired time after actuation of the inflator 24.

In the event of a side impact with the vehicle 12, an occupant's head 102, torso 104, or both are likely to strike the primary chambers 62 of the inflatable curtain 14. The occupants 100 may also strike the secondary chambers 64. In a scenario involving normally seated occupants, such as that illustrated in FIGS. 1 and 2, the occupants will most likely strike the primary chambers 62 first. Therefore, in the event of a side impact with the vehicle 12, such might occur if the vehicle struck a pole or another vehicle, it may be desirable to inflate and pressurize the primary chambers 62 to a predetermined minimum pressure before the secondary chambers 64 are inflated and pressurized to the predetermined minimum pressure. This predetermined minimum pressure may, for example, be a minimum pressure required to prevent strikethrough in the primary chamber 62, i.e., a minimum pressure required to prevent an occupant's head having a given mass from striking the side structure 16 through the inflated primary chamber when traveling at a given velocity. It will thus be appreciated that the predetermined minimum pressure may vary depending on a variety of factors, such as the inflated thickness of the primary chambers 62 and the desired criteria for strikethrough prevention.

In a rollover scenario of the vehicle 12, the inflatable curtain 14 serves the additional purpose of helping prevent the occupants 100 or portions of the occupants, such as limbs, from exiting the vehicle, for example, through the window openings 20. The inflatable curtain 14 is suited for this purpose because it is tensioned along its length and along the vehicle side structure 16. In the event of a pure rollover scenario, such as a rollover that results from a lateral skid of the vehicle 12 (with no side impact), the rollover evolves over a period of time greater than that over which a side impact evolves. Therefore, in the pure rollover scenario, the time within which the inflatable curtain 14 is inflated and deployed may be greater than that required for a side impact scenario. If, however, a vehicle impact, such as a side impact or an offset impact, occurs or is otherwise is involved in a rollover scenario, quicker inflation and pressurization of the primary chambers 62 may be required.

In view of the foregoing, those skilled in the art will appreciate that rapid inflation and pressurization of the primary chambers 62 is desirable in both a side impact and a vehicle rollover. According to the present invention, the passages 120 are configured such that the primary chambers 62 are inflated and pressurized before the secondary chambers 64. The time within which the primary chambers 62 are inflated and pressurized may depend on a variety of factors, such as the architecture of the vehicle 12 and the configuration of the inflatable curtain 14. For example, for the inflatable curtain 14 of FIGS. 1 and 2, the passages 120 may be configured such that the primary chambers 62 are inflated and pressurized within 25 milliseconds after actuation of the inflator 24.

The passages 120 are also configured such that the secondary chambers 64 are pressurized after the primary chambers 62 are pressurized. Inflation of the secondary chambers 64 may begin shortly after inflation of the primary chambers 62 begins and before the primary chambers are pressurized to the predetermined minimum pressure. The time within which the secondary chambers 64 are inflated and pressurized to the predetermined minimum pressure may depend on a variety of factors, such as the architecture of the vehicle 12 and the configuration of the inflatable curtain 14. For example, for the inflatable curtain of FIGS. 1 and 2, the passages 120 may be configured such that the secondary chambers 64 are inflated and pressurized to the predetermined minimum pressure within 1.5 seconds after actuation of the inflator 24. It will be appreciated, however, that the secondary chambers 64 may be inflated and pressurized to the predetermined minimum pressure more rapidly, such as within 50 milliseconds after actuation of the inflator 24.

The desired pressure to which the chambers 62, 64, and 68 are inflated may depend on a variety of factors, such as the inflated thickness of the curtain. For example, the desired pressure may be at least 5 psi. Thus, in the example set forth above, for the inflatable curtain 14 of FIGS. 1 and 2, the primary chambers 62 would be inflated to at least 5 psi within 25 milliseconds after actuation of the inflator 24. The secondary chambers 64 would be inflated to at least 5 psi after the primary chamber 62 is pressurized and within 1.5 seconds after actuation of the inflator 24.

From the above description of the invention, those skilled in the art will perceive improvements, changes and modifications. For example, the connections 60, the fill tube 22, or both could be re-configured such that the rearwardmost chamber of the inflatable curtain 14 in FIG. 2 is a secondary chamber 64. In this configuration, inflation fluid would be directed into this rearwardmost secondary chamber 64 only through the passage 120 from the adjacent primary chamber 62. The primary chamber 62 and secondary chamber 64 would be inflated and pressurized in a manner similar or identical to that described above with regard to the other primary and secondary chambers of the curtain. Such improvements, changes and modifications within the skill of the art are intended to be covered by the appended claims.

Having described the invention, the following is claimed:

1. Apparatus for helping to protect an occupant of a vehicle that has a side structure and a roof, said apparatus comprising:
an inflatable curtain that is inflatable away from the vehicle roof to a position between the side structure of the vehicle and a vehicle occupant, said inflatable curtain comprising:
a primary chamber extending from adjacent an upper edge of said inflatable curtain to adjacent a lower edge of said inflatable curtain;
a secondary chamber extending from adjacent said upper edge to adjacent said lower edge; and
at least one passage for directing inflation fluid from said primary chamber into said secondary chamber, said at least one passage being spaced from said upper edge and said lower edge, said at least one passage being the only means through which to direct inflation fluid into said secondary chamber.

2. The apparatus recited in claim 1, further comprising an actuatable inflation fluid source for directing inflation fluid into said primary chamber without first flowing into any other chamber to inflate said primary chamber to at least a predetermined pressure, said inflatable curtain blocking said inflation fluid source from directing inflation fluid into said secondary chamber without first flowing into any other chamber.

3. The apparatus recited in claim 1, further comprising an actuatable inflation fluid source and a conduit for directing inflation fluid from said inflation fluid source into said inflatable curtain, said conduit having a portion for directing inflation fluid directly into said primary chamber to inflate said primary chamber to at least a predetermined pressure, said conduit being free from portions for directing inflation fluid directly into said secondary chamber.

4. The apparatus recited in claim 3, wherein said conduit comprises a fill tube.

5. The apparatus recited in claim 1, further comprising an inflation fluid source actuatable to direct inflation fluid into said inflatable curtain, said at least one passage having a flow area sized to restrict inflation fluid flow into said secondary chamber so that said primary chamber is inflated to at least a predetermined pressure within a predetermined time after actuation of said inflation fluid source.

6. The apparatus recited in claim 5, wherein said flow area of said at least one passage is sized to inflate said secondary chamber to at least said predetermined pressure after said primary chamber is inflated to at least said predetermined pressure.

7. The apparatus recited in claim 6, wherein said at least one passage is sized such that said secondary chamber is inflated to at least said predetermined pressure within a predetermined time after actuation of said inflation fluid source.

8. The apparatus recited in claim 5, wherein said primary chamber is inflated to said predetermined pressure within 25 milliseconds after said inflation fluid source is actuated.

9. The apparatus recited in claim 8, wherein said secondary chamber is inflated to said predetermined pressure between 25 and 1500 milliseconds after said inflation fluid source is actuated.

10. The apparatus recited in claim 1, wherein said primary chamber when inflated overlies a portion of the vehicle side structure adjacent a location where a normally seated occupant of a vehicle seat may be positioned.

11. The apparatus recited in claim 10, wherein said secondary chamber when inflated overlies a portion of the vehicle side structure adjacent the portion that said primary chamber overlies.

12. The apparatus recited in claim 1, wherein said secondary chamber extends adjacent and generally parallel to said primary chamber.

13. The apparatus recited in claim 1, wherein said inflatable curtain comprises overlying panels defining an inflatable volume and connections within said inflatable volume that help define said primary and secondary chambers, said passage being defined between terminal end portions of at least one of said connections.

14. The apparatus recited in claim 13, wherein said passage is defined between terminal end portions of first and second connections, said first connection extending from said adjacent upper edge toward said lower edge, said second connection extending from adjacent said lower edge toward said upper edge.

15. The apparatus recited in claim 13, wherein each of said terminal end portions has a rounded configuration with a diameter larger than the width of a portion of said respective connections adjacent said terminal end portion.

16. Apparatus for helping to protect an occupant of a vehicle that has a side structure and a roof, said apparatus comprising:
an inflatable curtain that is inflatable away from the vehicle roof to a position between the side structure of the vehicle and a vehicle occupant; and
an inflator for providing inflation fluid for inflating said inflatable curtain;
said inflatable curtain comprising a primary chamber positioned for protecting the occupant's head in a side impact, a secondary chamber, and at least one passage for directing inflation fluid from said primary chamber into said secondary chamber, said at least one passage being sized to restrict flow into said secondary chamber so that said primary chamber is inflated to at least a predetermined pressure within a predetermined time after actuation of said inflator, and so that said secondary chamber is inflated to at least said predetermined pressure within a predetermined time after said primary chamber is inflated to said predetermined pressure.

17. Apparatus for helping to protect an occupant of a vehicle that has a side structure and a roof, said apparatus comprising:
an inflatable curtain that is inflatable away from the vehicle roof to a position between the side structure of the vehicle and a vehicle occupant; and
an inflation fluid source actuatable to provide inflation fluid for inflating said inflatable curtain, said inflatable curtain comprising:
a primary chamber;
a secondary chamber; and
at least one passage for directing inflation fluid from said primary chamber into said secondary chamber, said at least one passage being sized such that said primary chamber is inflated to at least a predetermined pressure within 25 milliseconds after actuation of said inflation fluid source and said secondary chamber is pressurized to at least said predetermined pressure after said primary chamber is pressurized to said predetermined pressure and within 1.5 seconds after actuation of said inflation fluid source.
